(19) United States
(12) Patent Application Publication
(10) Pub. No.: US 2005/0036742 A1
(43) Pub. Date: Feb. 17, 2005

(54) Molded fiber optic ferrule with integrally formed geometry features

(76) Inventors: David L. Dean JR., Hickory, NC (US); Robert B. Elkins II, Hickory, NC (US); James P. Luther, Hickory, NC (US)

Correspondence Address: CORNING CABLE SYSTEMS LLC, P O BOX 489, HICKORY, NC, 28603, US

(21) Appl. No.: 10/652,119

(22) Filed: Aug. 29, 2003

(51) Int. Cl. G02B 6/38

(52) U.S. Cl. 385/71

(57) ABSTRACT

A molded fiber optic ferrule includes a ferrule body having an end face and a geometry feature integrally formed on an exterior surface of the ferrule body. The ferrule body defines a plurality of fiber bores for receiving end portions of optical fibers and at least one opening through the end face adapted to receive an alignment member for aligning the optical fibers with corresponding end portions of the opposing optical fibers of a mating multifiber ferrule. The geometry feature may include a geometric reference feature or an end face having a first surface normal to the longitudinal axis of the ferrule body and a second surface disposed at an angle relative to the first surface and the longitudinal axis. The geometric reference feature may be utilized to determine the angularity of the end face or the height of the optical fibers relative to the surface of the end face.

### BACKGROUND OF THE INVENTION

1. Field of the Invention

The present invention relates generally to the field of multifiber connectors and, more specifically, to molded fiber optic ferrules with integrally formed geometry features.

2. Description of the Related Art

Optical fibers are used for a variety of applications including voice communications, data transmission and the like. In order to interconnect a plurality of optical fibers with a minimum amount of attenuation, a pair of multifiber connectors is preferably mated such that the opposing optical fibers are biased into contact with one another. To achieve optimal transmission without utilizing refractive index matching gel, the multifiber connectors must be precisely aligned in order to correspondingly align the individual optical fibers in the connectors. This alignment is typically provided by guide pins that extend outwardly from the end face of a male multifiber ferrule for insertion into corresponding guide pin openings, grooves or other structures defined by a female multifiber ferrule. In addition to precise alignment, the geometry of the ferrule and, in particular, the polish geometry of the end face of the ferrule, is extremely important to insure proper fiber-to-fiber contact. In this regard, at least the portion of the end face of each ferrule that is proximate to the optical fibers is preferably polished to define a plane extending perpendicular to the longitudinal axis defined by the guide pin openings and, therefore, perpendicular to the fiber bores. In addition, the planar surface defined by the portion of the end face of each ferrule proximate to the fiber bores is precisely positioned relative to the ends of the optical fibers. For example, with proper polish geometry, the optical fibers will extend by a predetermined distance beyond the end face of the ferrule so that fiber-to-fiber contact between opposing optical fibers is established. If, however, the polish geometry is not precisely defined, fiber-to-fiber contact may be prevented or otherwise obstructed by contact between those portions of the end faces of the opposing ferrules that extend beyond the ends of the optical fibers.

In order to monitor the polish geometry and the resulting quality of each ferrule, it is desirable to determine the planarity of the end face of the ferrule and the angle of the end face relative to the guide pin openings. As such, referring to prior art FIGS. 1a and 1b, a conventional ferrule 30 is shown in which an end face reference surface 32, also referred to herein as the “region of interest,” is measured for planarity. The end face reference surface 32 is an area on the end face 34 of the ferrule 30 in the vicinity of the plurality of fiber bores 42. Truncated measurement pins 33 having very precisely machined ends that extend from the end face 34 of the ferrule 30 are used to determine if the end face reference surface 32 of the ferrule 30 has been properly molded or machined to be planar. In order to determine the planarity of end face reference surface 32, the measurement pins 33 are inserted into guide pin openings 36 to define a measurement pin reference surface 38. Referring to FIG. 1b, the measurement pins 33 are machined to be very flat on one of their ends. The plane defined by the measurement pin reference surface 38 of one or both of the measurement pins 33 is then compared to the end face reference surface 32 using an interference vision system, such as an interferometer having 3D capabilities. After comparative measurements have been made and the planarity of the end face reference surface 32 confirmed, the measurement pins 33 are removed from the guide pin openings 36 and replaced with conventional guide pins to produce a male ferrule. A female ferrule is produced with vacant guide pin openings 36 operable for receiving the guide pins of a respective male ferrule. Predetermined lengths of optical cable may then be produced by combining sections of cable comprising mating male and female ferrules.

There are several disadvantages associated with using truncated precision measurement pins 33 to measure the planarity of the end face reference feature 32 and/or the angularity of the end face 34. For one, the measurement pins 33 are very expensive to manufacture because of the very precise machining of one of their ends. Furthermore, the measurement pins 33 may be easily lost due to their extremely small size. Also, when using the ends of the measurement pins 33 as a reference surface, it is necessary to make the optical measurements using a relatively expensive interference vision system having 3D capabilities. Still further, with conventional multifiber ferrules, male multifiber ferrules cannot be measured for planarity after assembly due to the difficulty in removing the guide pins without damaging the ferrule assembly.

In particular instances, it is desired to produce a ferrule having an end face with an angle other than normal (i.e., perpendicular) to the longitudinal axis of the ferrule body. In such cases, the angle is typically introduced by machining the end face of the ferrule subsequent to the molding process. By machining the angle as opposed to molding it, the end face of every ferrule must be individually machined after the ferrule is removed from the mold. This subsequent machining step leads to a decrease in ferrule uniformity and an increase in ferrule production time. Therefore, it would be desirable to rapidly and economically produce a large number of substantially identical ferrules having an end face with a predetermined angle relative to the longitudinal axis of the ferrule body, without having to machine each ferrule subsequent to the molding process.

Thus, there is a need in the art for a fiber optic ferrule that eliminates the need for using truncated precision measurement pins and an interference vision system having 3D capabilities to determine the planarity of the region of interest on the end face of the ferrule. Such ferrule should have integral geometry features that permit planarity measurements of at least the region of interest of the end face, and angularity measurements of the entire end face, to be determined more readily and more economically. Such ferrule should substantially reduce ferrule manufacturing, assembly and quality inspection times. Such ferrule should allow for region of interest planarity and end face angularity measurements to be made for both male and female ferrules after ferrule assembly and throughout the life of the ferrule. Such ferrule should eliminate the step of having to machine a predetermined angle on the end face of the ferrule subsequent to the molding process.

### BRIEF SUMMARY OF THE INVENTION

To achieve the foregoing and other objects, the present invention, as embodied and broadly described herein, provides various embodiments of multifiber ferrules comprising a molded ferrule body having an end face and defining a plurality of bores extending through the ferrule body for receiving end portions of respective optical fibers, the ferrule body further defining at least one opening through the end face adapted to receive an alignment member for aligning the end portions of the respective optical fibers with corresponding end portions of optical fibers of a mating multifiber ferrule, and at least one integrally formed geometric reference feature molded on an exterior surface of the ferrule for determining end face planarity and angularity, wherein the end face is not machined subsequent to the molding process. The molded ferrule body having the at least one molded-in geometry feature eliminates the need for using at least one truncated precision measurement pin and an interference vision system having 3D capabilities to determine the planarity of the region of interest on the end face and/or the angularity of the end face relative to a reference plane defined by the truncated end of the measurement pin.

In various embodiments, a multifiber ferrule is described comprising a molded ferrule body having an end face and defining a plurality of bores extending through the ferrule body for receiving end portions of respective optical fibers, the ferrule body further defining at least one opening through the end face adapted to receive an alignment member for aligning the end portions of the respective optical fibers with corresponding end portions of optical fibers of a mating multifiber ferrule, the opening defining a longitudinal axis extending at least partially through the ferrule body, and wherein the end face comprises a first surface defining a first plane that is generally normal to the longitudinal axis, and a second surface defining a second plane disposed at a predetermined angle relative to the first plane and the longitudinal axis. The first and second surfaces are formed by a precision molding process, thereby eliminating the need for machining the predetermined angle of the end face subsequent to the molding process. In various embodiments, a ferrule having an end face with a predetermined angle relative to the longitudinal axis of the ferrule body may further comprise a geometric reference feature disposed adjacent to the end face.

In another embodiment, a method is provided whereby a multifiber ferrule is molded comprising a ferrule body having an end face and defining a plurality of bores extending through the ferrule body for receiving end portions of respective optical fibers, the ferrule body also defining at least one opening through the end face adapted to receive a guide pin for aligning the end portions of the respective optical fibers with corresponding end portions of optical fibers of a mating multifiber ferrule, the opening defining a longitudinal axis extending at least partially through the ferrule body, the ferrule body further comprising a geometric reference feature adjacent to the end face operable for determining end face planarity and angularity subsequent to the molding process and throughout the useful life of the ferrule.

In a further embodiment, a method is provided whereby a multifiber ferrule is molded comprising a ferrule body having an end face and defining a plurality of bores extending through the ferrule body for receiving end portions of respective optical fibers, the ferrule body also defining at least one opening through the end face adapted to receive a guide pin for aligning the end portions of the respective optical fibers with corresponding end portions of optical fibers of a mating multifiber ferrule, the opening defining a longitudinal axis extending at least partially through the ferrule body, the end face comprising a first surface defining a first plane that is generally normal to the longitudinal axis, and a second surface disposed at a predetermined angle relative to the first surface and the longitudinal axis defined by the opening of the ferrule body.

### BRIEF DESCRIPTION OF THE DRAWINGS

The above described and other features, aspects, and advantages of the present invention are better understood when the following detailed description of the invention is read with reference to the accompanying drawings, wherein:

FIGS. 1a and 1b are perspective and enlarged end face views, respectively, of a prior art fiber optic ferrule in which at least one truncated precision measurement pin is used to determine the planarity of a region of interest on the end face of the ferrule and/or the angularity of the end face relative to a reference plane;

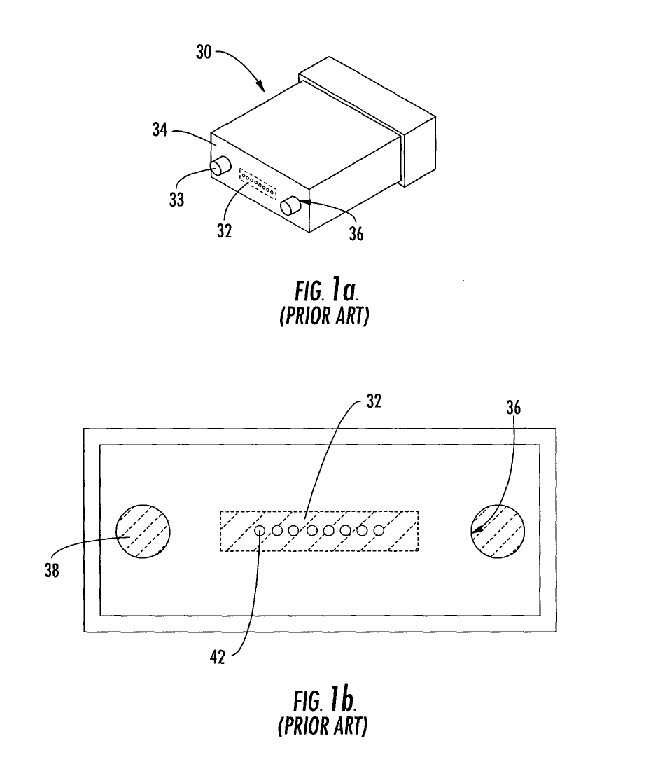

FIGS. 2a-c are perspective, top plan and enlarged top plan views, respectively, of a molded fiber optic ferrule having outwardly extending bumpers, an end face and a recessed integrally molded geometric reference feature in accordance with an exemplary embodiment of the present invention;

FIG. 2d is an enlarged end face view of the molded ferrule of FIG. 2a identifying the plane defined by the integral geometric reference feature and the plane defined by the end face reference feature in accordance with an exemplary embodiment of the present invention;

FIGS. 3a and 3b are perspective and enlarged end face views, respectively, of a molded fiber optic ferrule without outwardly extending bumpers having a recessed geometric reference feature in accordance with an exemplary embodiment of the present invention;

FIGS. 4a and 4b are perspective and enlarged end face views, respectively, of a molded fiber optic ferrule having an inwardly-stepped geometric reference feature within each guide pin opening in accordance with an exemplary embodiment of the present invention;

FIGS. 5a and 5b are perspective and enlarged end face views, respectively, of a molded fiber optic ferrule having a pair of recessed, spaced apart geometric reference features in accordance with an exemplary embodiment of the present invention;

FIGS. 6a and 6b are perspective and enlarged cross-sectional views, respectively, of a molded fiber optic ferrule having outwardly extending bumpers and geometric reference features that taper inwardly from the bumpers in accordance with an exemplary embodiment of the present invention, the ferrule is shown subsequent to the molding process and prior to any fiber polishing and/or grinding process;

FIGS. 6c and 6d are perspective and enlarged cross-sectional views, respectively, corresponding to the molded fiber optic ferrule of FIGS. 6a and 6b following a fiber polishing process in accordance with an exemplary embodiment of the present invention;

FIGS. 7a-c are perspective views illustrating various embodiments of a molded fiber optic ferrule having outwardly extending bumpers and angled geometric reference features in accordance with an exemplary embodiment of the present invention;

FIGS. 8a and 8b are perspective and enlarged cross-sectional views, respectively, of a molded fiber optic ferrule having a single, outwardly extending geometric reference feature disposed on the end face in accordance with an exemplary embodiment of the present invention;

FIGS. 8c and 8d are perspective and enlarged cross-sectional views, respectively, of a molded fiber optic ferrule having a pair of outwardly extending geometric reference features diametrically disposed on the end face in accordance with an exemplary embodiment of the present invention;

FIGS. 9a and 9b are perspective and enlarged cross-sectional views, respectively, of a molded fiber optic ferrule having a pair of outwardly extending bumpers, and a pair of outwardly extending geometric reference features diametrically disposed on the end face in accordance with an exemplary embodiment of the present invention;

FIGS. 10a and 10b are perspective and enlarged end face views, respectively, of a molded fiber optic ferrule having outwardly extending bumpers and geometric reference features that taper inwardly into the guide pin openings in accordance with an exemplary embodiment of the present invention;

FIGS. 11a-c are perspective, end face and enlarged cross-sectional views, respectively, of a molded fiber optic ferrule having a recessed geometric reference feature and an end face having a first surface normal to the longitudinal axis of the ferrule and a second surface disposed at an angle relative to the first surface and the longitudinal axis, wherein a region of interest is located on the second surface in accordance with an exemplary embodiment of the present invention;

FIGS. 12a-c are perspective, end face and enlarged cross-sectional views, respectively, of a molded fiber optic ferrule having a pair of outwardly extending bumpers and an end face having a first surface normal to the longitudinal axis of the ferrule, and a second surface disposed at an angle relative to the first surface and the longitudinal axis, wherein a region of interest is located on the second surface in accordance with an exemplary embodiment of the present invention;

FIGS. 13a-c are perspective, end face and enlarged cross-sectional views, respectively, of a molded fiber optic ferrule having an end face comprising a first surface normal to the longitudinal axis of the ferrule, and a second surface disposed at an angle relative to the first surface and the longitudinal axis, wherein the plurality of fiber bores are located on the first surface in accordance with an exemplary embodiment of the present invention; and

FIGS. 14a-c are perspective, end face and enlarged cross-sectional views, respectively, of a molded fiber optic ferrule having a pair of outwardly extending bumpers and an end face comprising a first surface normal to the longitudinal axis of the ferrule and a second surface disposed at an angle relative to the first surface and the longitudinal axis, wherein the separation line between the first surface and the second surface passes through the plurality of fiber bores in accordance with an exemplary embodiment of the present invention.

### DETAILED DESCRIPTION OF THE INVENTION

The present invention will now be described more fully hereinafter with reference to the accompanying drawings in which preferred embodiments of the invention are shown. This invention may, however, be embodied in many different forms and should not be construed as limited to the embodiments set forth herein. These exemplary embodiments are provided so that this disclosure will be both thorough and complete, and will fully convey the scope of the invention to those skilled in the art. Like reference numbers refer to like elements throughout the various drawings.

The present invention describes molded fiber optic ferrules and methods for making the same. In various embodiments, the molding process produces a fiber optic ferrule having an integrally formed geometry feature. In specific embodiments, the molding process produces a ferrule having at least one geometric reference feature disposed on an exterior surface of the ferrule body adjacent to an end face reference surface. The geometric reference feature eliminates the need for using truncated precision measurement pins and an interference vision system having 3D capabilities to measure the planarity of a region of interest on the end face of the ferrule and/or the angularity of the end face relative to a plane defined by the truncated end of the measurement pin. The term “region of interest” is used herein to describe at least a portion of the end face in the vicinity of the plurality of fiber bores. The geometric reference feature may be used to precisely determine the planarity of the region of interest. The integrally formed geometry feature may comprise a geometric reference feature, a reference datum, a measurement datum, a polishing angle or an end face comprising a first surface defining a first plane and a second surface defining a second plane, wherein the second surface is disposed at a predetermined angle relative to the first surface and the longitudinal axis of the ferrule body. Throughout the disclosure, the molded-in geometric reference feature may be used as a datum to measure fiber height and/or end face planarity. At least one end face angle may be determined based upon an angular difference between the reference plane defined by the geometric reference feature and a corresponding plane defined by the end face of the ferrule.

In one embodiment, the present invention provides a method for determining an end face angle of a fiber optic ferrule having a geometric reference feature defined by the ferrule body. The method comprises molding a fiber optic ferrule with an integrally formed geometric reference feature disposed proximate to the end face of the ferrule, measuring a reference plane defined by the geometric reference feature, measuring a plane defined by at least a portion of the end face of the ferrule (i.e., the region of interest), and determining at least one end face angle based upon an angular difference between the reference plane defined by the geometric reference feature and the plane defined by the end face of the ferrule.

In various embodiments described below, a multifiber ferrule is provided comprising a molded ferrule body having an end face that is not machined subsequent to the molding process. As used herein throughout the specification, machining includes any manufacturing or assembly process intended to remove more than an insubstantial amount of material from the end face, or to shape the end face to a predetermined configuration, such as grinding, etching, etc. As used herein, machining is not intended to include fiber polishing and cleaning. The end face defines a plurality of fiber bores extending through the ferrule body for receiving end portions of respective optical fibers. The ferrule body defines at least one guide pin opening through the end face adapted to receive an alignment member for aligning the end portions of the respective optical fibers with corresponding end portions of the opposing optical fibers of a mating multifiber ferrule. The guide pin opening defines a longitudinal axis extending at least partially through the ferrule body and parallel to the fiber bores and the longitudinal axis of the ferrule body. The ferrule body further comprises a geometry feature integrally formed on an exterior surface of the ferrule body that is formed during the molding process.

In one example, the geometry feature may be a geometric reference feature, such as a reference datum, used to measure end face planarity and angularity subsequent to molding and throughout the useful life of the ferrule. In contrast to the shoulder portion of the ferrule body, the geometric reference feature of the present invention is disposed adjacent to the end face and remains visually accessible even after the ferrule is assembled into a conventional fiber optic connector. In contrast to the prior art, the geometric reference feature of the present invention may be used as a reference to determine the angularity of the end face of an assembled male ferrule. Thus, the geometric reference feature may be utilized as a permanent point of reference.

In various embodiments described below, a multifiber ferrule is provided comprising a molded ferrule body having an end face that is not machined subsequent to the molding process. The ferrule body defines a plurality of fiber bores extending through the ferrule body for receiving end portions of respective optical fibers. The ferrule body further defines at least one opening through the end face adapted to receive an alignment member for aligning the end portions of the respective optical fibers with corresponding end portions of the opposing optical fibers of a mating multifiber ferrule. The opening defines a longitudinal axis extending at least partially through the ferrule body and parallel to the fiber bores. The end face further defines a first surface defining a first plane that is generally normal to the longitudinal axis, and a second surface defining a second plane disposed at a predetermined angle relative to the first surface and the longitudinal axis, wherein both surfaces are formed by molding and not by machining subsequent to the molding process.

As known to those skilled in the art, the ferrule may be assembled according to any conventional technique for assembling multifiber ferrules. In one assembly example, the ferrule may be molded defining a pair of guide pin openings and a predetermined number of fiber bores extending through the ferrule body for receiving a plurality of optical fibers. An adhesive may be inserted into the fiber bores, followed by the optical fibers. For a male ferrule, an adhesive and guide pins are also inserted into the guide pin openings. The ferrule assembly is then allowed to dry or cure in a conventional oven, autoclave, or the like, in a known manner.

In various embodiments, the method for forming the multifiber ferrule comprises molding a ferrule body having an end face that is not machined subsequent to the molding process. The ferrule body defines a plurality of fiber bores extending through the ferrule body for receiving end portions of respective optical fibers, the ferrule body also defines at least one opening through the end face adapted to receive a guide pin for aligning the end portions of the respective optical fibers with corresponding end portions of the opposing optical fibers of a mating multifiber ferrule. The guide pin openings define a longitudinal axis extending at least partially through the ferrule body and parallel to the fiber bores. The ferrule body further comprises a geometry feature on an exterior surface of the ferrule body.

In various embodiments, the method for forming a multifiber ferrule comprises molding a ferrule body comprising an end face that is not machined subsequent to the molding process. The end face defines a plurality of fiber bores extending through the ferrule body for receiving end portions of respective optical fibers. The ferrule body further defines at least one opening through the end face adapted to receive a guide pin for aligning the end portions of the respective optical fibers with corresponding end portions of the opposing optical fibers of a mating multifiber ferrule. The opening defines a longitudinal axis extending at least partially through the ferrule body and parallel to the fiber bores. Further, the end face comprises a first surface defining a first plane that is generally normal to the longitudinal axis, and a second surface defining a second plane disposed at a predetermined angle relative to the first surface and the longitudinal axis of the ferrule body.

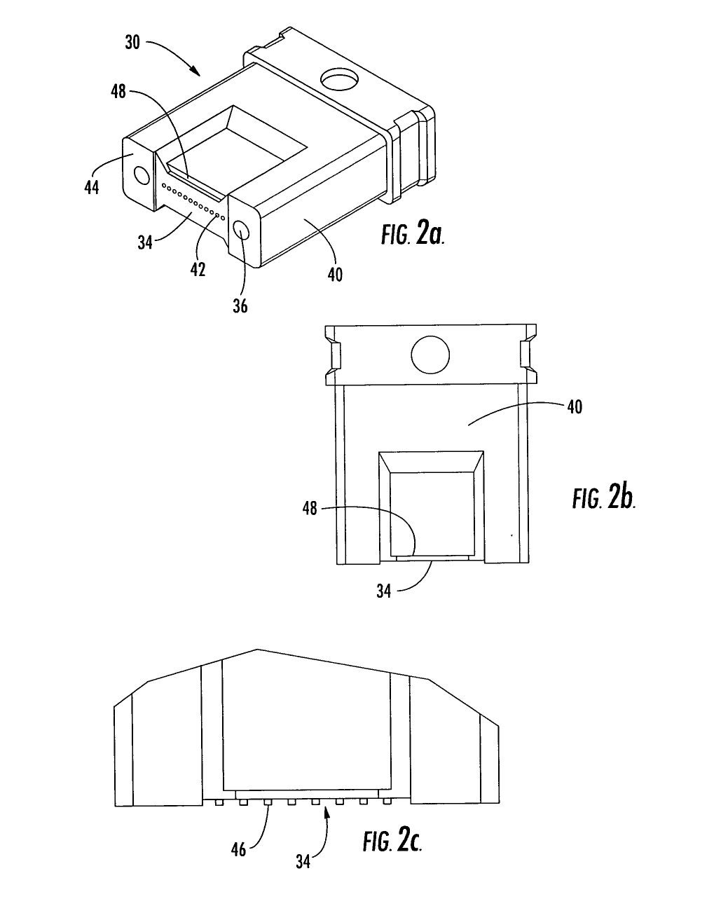

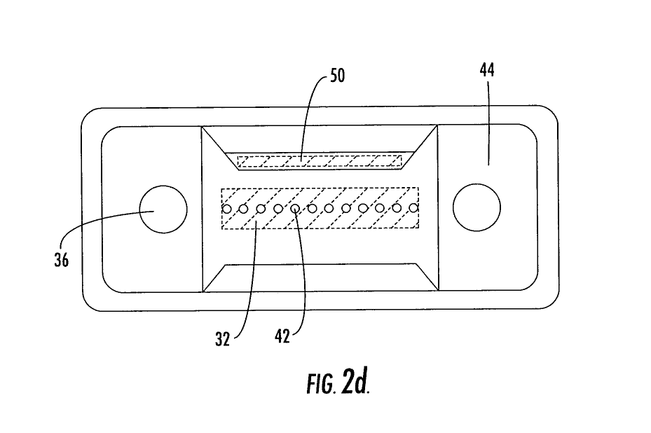

Referring to FIGS. 2a-2d, in one embodiment the molded fiber optic ferrule 30 mounted upon the end portions of the optical fibers generally includes a ferrule body 40 having a generally rectangular-shaped end face 34. Referring to FIG. 2d, while the end face 34 of the ferrule 30 of the present invention comprises a region of interest 32 on the end face 34 in the vicinity of the fiber bores 42, the remainder of the ferrule may have any desired shape and, as such, may have the shape of any conventional ferrule including, but not limited to, a multifiber ferrule, such as an MTP, MT-RJ, MPO or SC/DC ferrule, or a single fiber ferrule, such as an SC, ST, or LC ferrule.

The ferrule body 40 defines at least one fiber bore 42 extending along a longitudinal axis of the ferrule body 40 and adapted to receive an optical fiber 46. While the ferrule of the present invention may be a single fiber ferrule that defines only a single fiber bore 42, the ferrule of the present invention will be hereinafter described in conjunction with embodiments in which the ferrule is a multifiber ferrule that defines a plurality of fiber bores 42 adapted to receive a plurality of optical fibers 46. In addition, while the multifiber ferrules are shown having only a single row of fiber bores 42, the molded ferrule may comprise any number of fiber bores 42 arranged in any predetermined manner including, but not limited to, multiple rows of fiber bores 42 (e.g., a multiple row, multifiber array). Typically, multifiber ferrules also define at least one and, more commonly, a pair of guide pin openings 36 adapted to receive respective alignment members, such as guide pins (not shown).

As shown in FIG. 2a, the plurality of fiber bores 42 generally open through a medial portion of the end face 34 of the ferrule body 40, while the guide pin openings 36 generally open through a lateral portion of the end face 34 of the ferrule body 40. At least one and preferably a pair of bumpers 44 extend outwardly in a forward direction relative to the end face 34. Referring to FIG. 2c, the plurality of optical fibers may extend a predetermined amount beyond the surface of the end face 34. In all embodiments, the amount of protrusion of the optical fibers from the end face 34 may be in the range from about 0 to about 15 microns, more preferably from about 3 to about 15 microns. A molded geometric reference feature 48 is located adjacent to, and recessed from, the end face 34. The geometric reference feature 48 comprises a predetermined shape and defines a geometric feature reference surface 50, as shown in FIG. 2d.

To ensure good contact between optical fibers, and thus good optical transmission at the ferrule end face 34, the end face 34 should be polished perpendicular to the fiber bores 42. The guide pin openings 36 are generally parallel to the fiber bores 42, since the guide pin openings 36 and the guide pins are used to align mating ferrules, and particularly the opposing optical fibers of mating ferrules. The bumpers 44 may provide a polishing plane for one step in obtaining coplanarity of the optical fibers 46. As such, the height of the bumpers 44 after polishing may be used as a reference to determine the height of the optical fibers 46. The bumpers 44 are eventually ground down to a predetermined depth, for example, the bumpers 44 may be entirely removed down to the end face 34. As stated above, the end face reference surface 32 is not machined subsequent to the molding process. In various embodiments, the geometric feature reference surface 50 of the molded geometric reference feature 48 is adjacent to and recessed from the end face 34, and therefore is not altered subsequent to the molding process, even when the bumpers 44 are entirely removed. By existing as a permanent molded feature of the ferrule body 40, the geometric feature reference surface 50 is not altered or otherwise disturbed throughout the useful life of the ferrule 30.

In various embodiments, the optical fibers 46 may be polished substantially normal (i.e., perpendicular) to the longitudinal axis of the ferrule body 40, resulting in a “best fit” plane of the fibers 46 that is substantially parallel to both the plane defined by the geometric feature reference surface 50 and the plane defined by the end face reference surface 32. The geometric reference feature 48 may be used to verify the geometry of the end face reference surface 32 both before and after polishing. In order to determine angularity between the surfaces 32 and 50, the end face reference surface 32 and the geometric feature reference surface 50 may be measured and compared using a non-interference vision system. In alternative embodiments, an interference vision system may be used to determine angularity of the surface 32 relative to the surface 50. The surfaces 32, 50 may be measured and compared to determine relative parallelness. In other words, the geometric feature reference surface 50 may be used as a datum surface to determine the angularity of the end face reference surface 32. As stated above, it is desirable that the reference surfaces 32, 50 are substantially parallel, and more preferably, exactly parallel. It is also desirable that the end face reference surface 32 be polished normal to the longitudinal axis of the ferrule body 40, particularly in the direction of its long axis (i.e., X-direction).

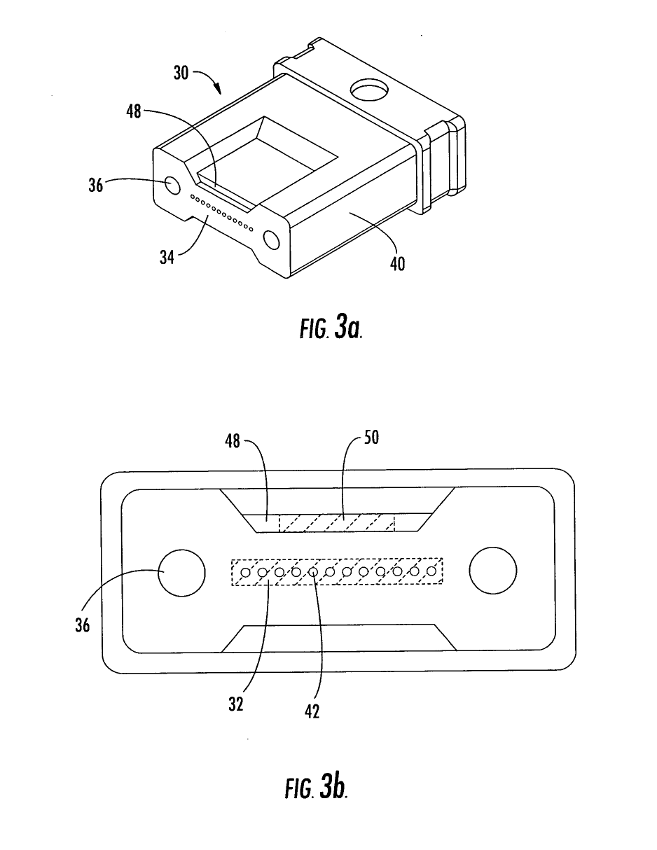

Referring to FIGS. 3a and 3b, in another embodiment the molded fiber optic ferrule 30 includes a ferrule body 40 having an end face 34 and an end face reference surface 32. A plurality of fiber bores 42 open through a medial portion of the end face 34 of the ferrule body 40. In contrast to the embodiment show in FIGS. 2a-2d, the ferrule 30 shown in FIGS. 3a and 3b does not comprise bumpers. In order for contact between opposing optical fibers (i.e., fiber-to-fiber) contact to be established, the optical fibers (not shown) may protrude a predetermined amount from the surface of the end face 34. In all embodiments of the present invention, it is also envisioned that the optical fibers may be polished generally flush with the surface of the end face 34. As previously described, the molded geometric reference feature 48 is located adjacent the top surface of the ferrule body 40 proximate to, and recessed from, the end face 34. However, the geometric reference feature 48 may be located adjacent the opposite side (i.e., bottom surface), or adjacent both the top and bottom surfaces of the ferrule body 40. Furthermore, the geometric reference feature 48 may be located more distant from the end face 34, as long as the distance between the geometric reference feature 48 and the end face 34 does not introduce significant errors into the measurement system utilized to determine the planarity of the end face reference surface 32. The geometric reference feature 48 comprises a geometric feature reference surface 50 that is precisely perpendicular to the longitudinal axis of the guide pin openings 36. As stated above, the geometric reference feature 48 is recessed from the end face 34 and is not altered during the useful life of the ferrule 30. The end face reference surface 32 and the geometric feature reference surface 50 may be measured and compared using a non-interference vision system. The measurements may then be used to determine if the end face reference surface 32 is parallel to or at an angle to the geometric feature reference surface 50, and thus, the longitudinal axis of the ferrule body 40.

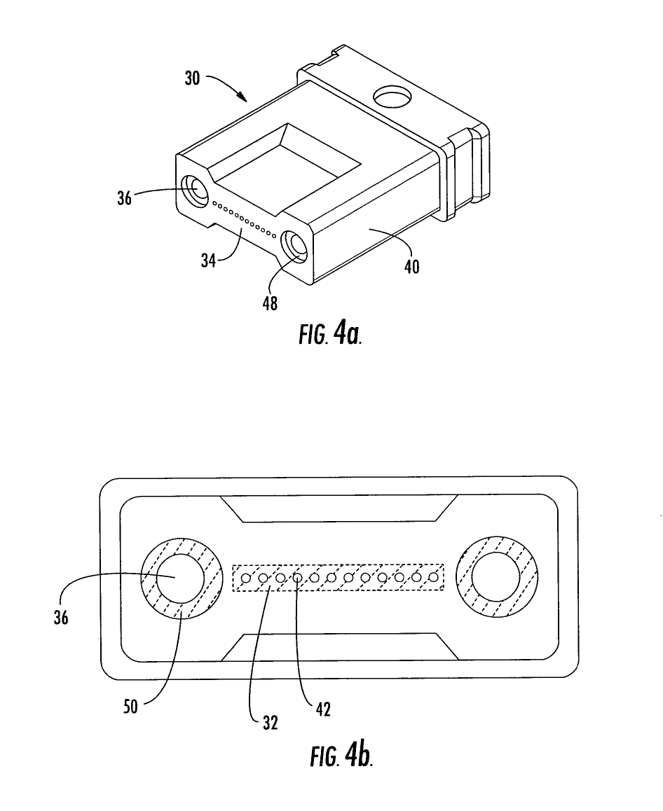

Referring to FIGS. 4a and 4b, in a further embodiment a molded fiber optic ferrule 30 is shown in which the molded guide pin openings 36 define inwardly-stepped geometric reference features 48. In this embodiment, the inwardly-stepped reference features 48 have a generally circular shape and define the corresponding geometric feature reference surfaces 50 identified in FIG. 4b. As with the embodiment shown in FIGS. 3a and 3b, the ferrule body 40 is molded such that the fiber bores 42 open through the forwardmost and medial portion of the end face 34. By recessing the geometric reference features 48 from the end face 34, the geometric feature reference surfaces 50 are not disturbed throughout the useful life of the ferrule 30. The geometric feature reference surfaces 50 are protected from any subsequent machining or polishing processes, thereby providing permanent reference planes. The end face reference surface 32 may be measured and compared to the geometric feature reference surfaces 50 using a non-interference vision system. As with the embodiments described above, the end face reference surface 32 and the geometric feature reference surfaces 50 may be compared for relative angularity both before and after polishing. In all embodiments, if it is determined that the end face reference surface 32 is at an angle to a geometric feature reference surface 50, the ferrule 30 may be rejected or the end face 34 subsequently machined to substantially eliminate the angle between the end face reference surface 32 and the geometric feature reference surface 50. After any subsequent machining of the end face 34, the end face reference surface 32 and the geometric feature reference surface 50 may be compared again for parallelness. Additional machining and polishing processes may be performed and repeated until surfaces 32 and 50 are rendered substantially parallel.

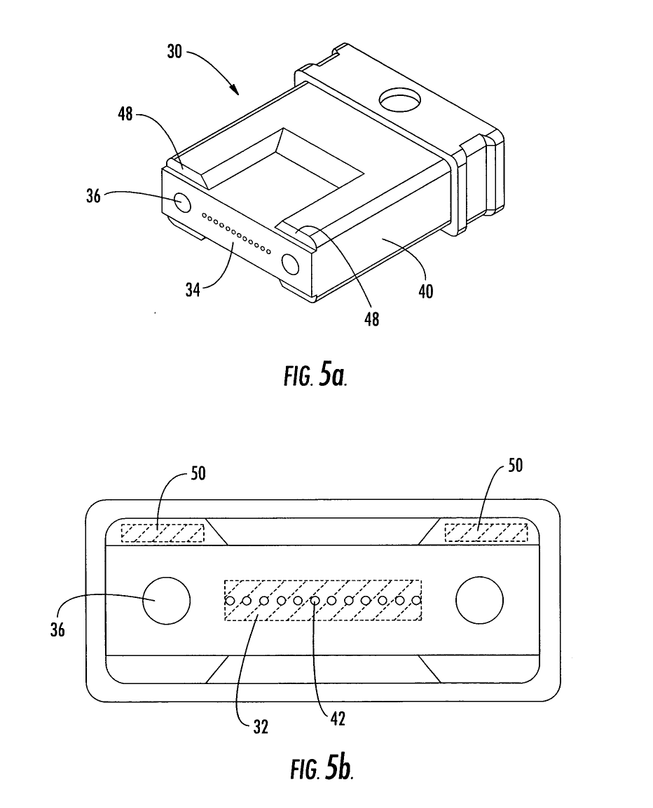

Referring to FIGS. 5a and 5b, in a still further embodiment a molded fiber optic ferrule 30 is shown in which a plurality of molded-in (i.e., integrally formed) geometric reference features 48 are recessed from the end face 34. As shown in FIG. 5a, the plurality of fiber bores 42 and the guide pin openings 36 open through the end face 34 of the ferrule body 40. The geometric reference features 48 are generally trapezoid-shaped and disposed at the front corners of the ferrule body 40 adjacent the top surface. However, it is envisioned that that the geometric reference features 48 may be of any shape and may be disposed at any location from which a measurement of a geometric feature reference surface 50 may be readily obtained. In order to determine angularity between surfaces 32 and 50, the geometric feature reference surface 50 may be measured and compared to the end face reference surface 32 using a non-interference vision system. As shown in FIG. 5a, the geometric reference features 48 are recessed from the end face 34 and are not altered throughout the useful life of the ferrule 30.

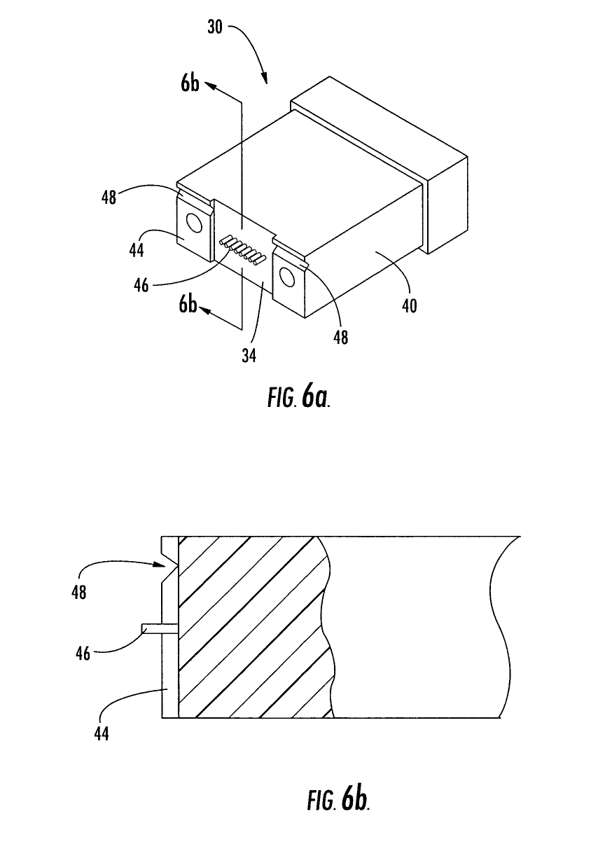

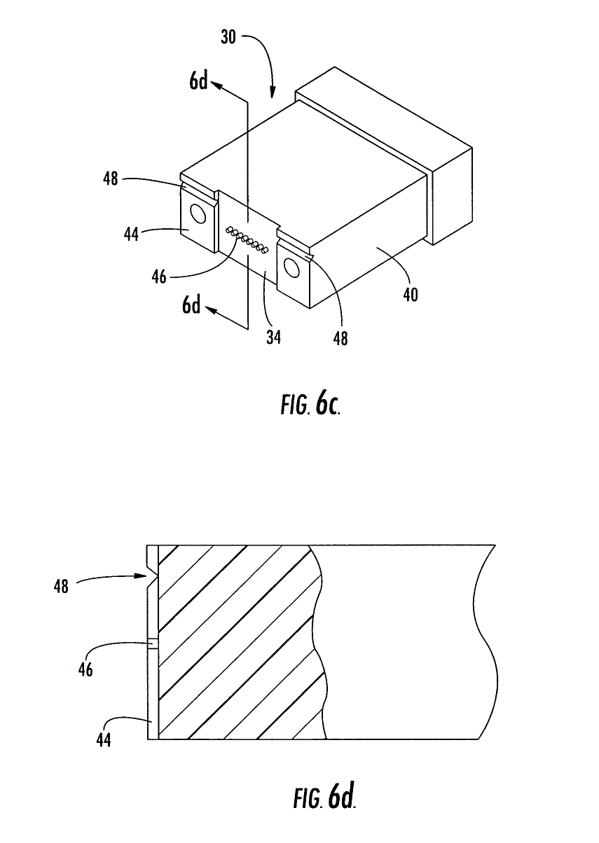

Referring to FIGS. 6a-6d, in a still further embodiment a molded fiber optic ferrule 30 is shown in which the molded-in geometric reference feature 48 comprises a recessed, non-orthogonal (i.e., V-shaped) horizontally disposed groove formed in a bumper 44. FIGS. 6a and 6b show the protrusion of the optical fibers 46 and the bumpers 44 prior to polishing. FIGS. 6c and 6d show the protrusion of the optical fibers 46 and the bumpers 44 after polishing. The plurality of optical fibers 46 may protrude from the end face 34 of the ferrule body 40 or may be polished flush with the end face 34. The guide pin openings 36 open through the bumpers 44. Referring to FIGS. 6a and 6b, the optical fibers 46 extend beyond the surface of the bumpers 44 and the geometric reference features 48 prior to polishing. After polishing, as shown in FIGS. 6c and 6d, the depth of the non-orthogonal geometric reference features 48, as well as the length of the protruding optical fibers 46, is reduced. By measuring the angled surfaces of the geometric reference features 48 both prior to and after polishing, the amount of material removed from the bumpers 44 during polishing may be determined. From the resultant height of the bumpers 44, the height of the protruding optical fibers 46 may be determined. In contrast to the embodiments shown in FIGS. 2-5, the geometric reference features 48 shown in FIGS. 6-9 are altered during a polishing process and preferably are subsequently removed, such as by grinding or laser cutting.

By measuring and comparing the depth of the non-orthogonal geometric reference features 48 before (e.g., using the tooling dimensions of the ferrule mold) and after polishing (e.g., viewing the geometric reference features 48 using a non-interference vision system), changes in the depths of the geometric reference features 48 may be determined. The depth changes are then utilized to determine how much of the bumpers 44 and the optical fibers 46 have been ground or polished away. In addition, by comparing the depths of the left-hand and right-hand geometric reference features 48, the polishing angle in the direction of the long axis (i.e., X-direction) of the end face 34 may be determined. An end face 34 polished normal to the longitudinal axis of the ferrule body 40 results in both the left-hand and right-hand reference features 48 having the same shape and depth after polishing. After polishing and measuring, the bumpers 44 may be removed to a predetermined depth, such as to the surface of the end face 34, thereby reducing or eliminating the geometric reference features 48 altogether.

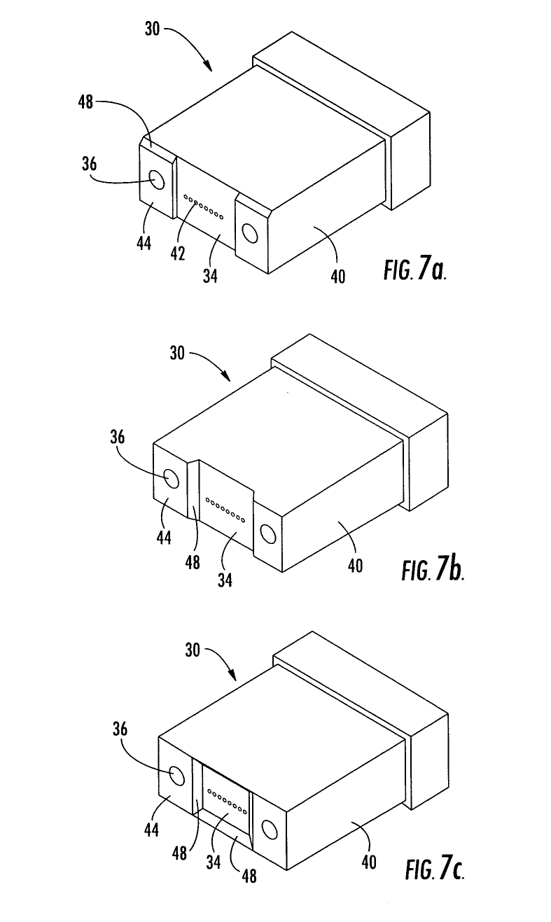

Referring to FIGS. 7a-7c, in a still further embodiment various examples of molded fiber optic ferrules 30 with bumpers 44 having angled geometric reference features 48 are shown. The plurality of fiber bores 42 generally open through a medial portion of the end face 34 of the ferrule body 40. The bumpers 44 extend outwardly from the end face 34 a predetermined distance. Although not shown, the optical fibers preferably protrude from the surface of the end face 34. The molded geometric reference features 48 comprise a predetermined angle relative to the surface of the end face 34. The height of each bumper 44 and geometric reference feature 48 may be reduced during the polishing process and/or cleaning process. After polishing, the height of optical fibers 46 may be determined by measuring the resulting height of the bumper 44 or geometric reference feature 48. Referring to FIG. 7a, one or more geometric reference features 48 extending at an angle between the top surface of the ferrule body 40 and a bumper 44 may be used to determine the polishing angle in the direction of the long axis (i.e., X-direction) of the end face 34. Referring to FIG. 7b, one or more geometric reference features 48 extending at an angle between the surface of the end face 34 and a bumper 44 may be used to determine the polishing angle in the direction of the short axis (i.e., Y-direction) of the end face 34. Referring to FIG. 7c, one or more geometric reference features 48 extending at an angle between the top surface of the ferrule body 40 or the surface of the end face 34 and bumper 44 may be used to determine the polishing angles in the direction of both the long axis (i.e., X-direction) and the short axis (i.e., Y-direction) of the end face 34.

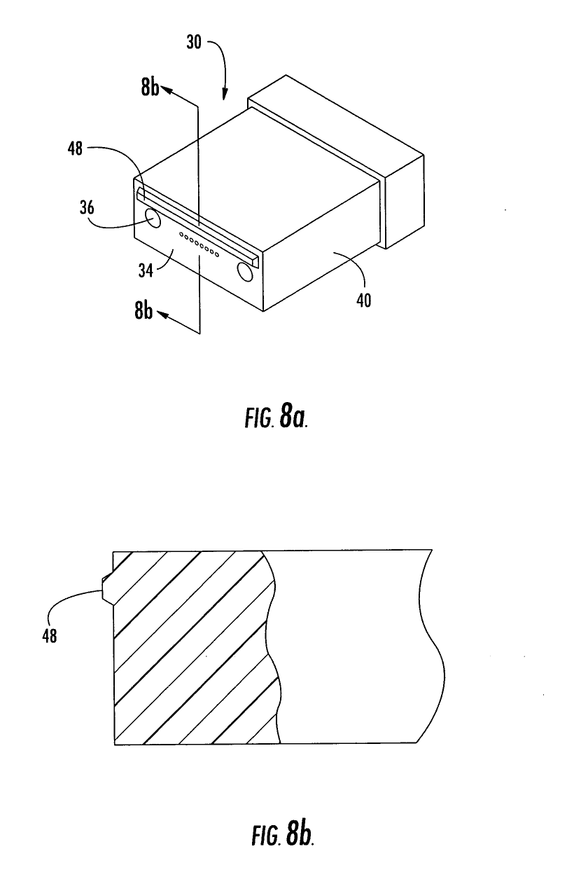

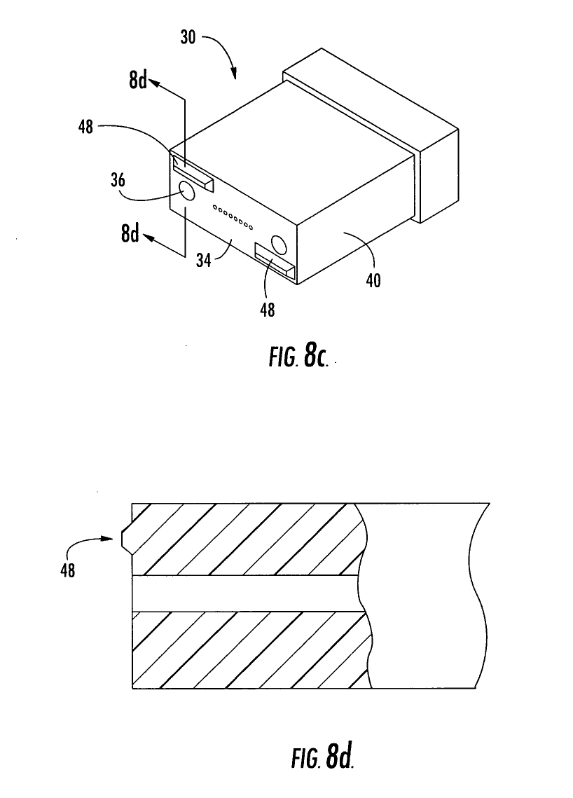

Referring to FIGS. 8a-8d, in a still further embodiment two examples of molded fiber optic ferrules 30 having outwardly extending geometric reference features 48 are shown. As shown in FIGS. 8a and 8b, a single elongate, trapezoid-shaped geometric reference feature 48 protrudes outwardly from the surface of the end face 34. As shown in FIGS. 8c and 8d, a pair of trapezoid-shaped geometric reference features 48 protrudes from the surface of the end face 34 at diametrically opposed corner locations. Although not shown, the optical fibers may be flush with the surface of the end face 34, but preferably protrude therefrom. While the molded geometric reference features 48 are shown having a trapezoid shape, it is envisioned that the geometric reference features 48 may comprise any shape, such as, but not limited to, rectangular, spherical, pyramidal, conical, etc. As the protruding optical fibers and the geometric reference feature 48 are polished, the frontal surface area of the geometric reference feature 48 increases. By measuring the height of the geometric reference feature 48 or the area of the frontal surface after polishing, the height of the polished optical fibers may be determined. In addition, by comparing the surface of the single geometric reference feature 48 (FIG. 8a) across the entire surface, or the surfaces of the pair of separate geometric reference features 48 (FIG. 8c), it may be determined whether the end face 34 was polished normal to the longitudinal axis of the ferrule body 40. A non-uniform removal of the geometric reference feature(s) 48 along the frontal surface may be used to determine the angularity of the end face 34 relative to the guide pin openings 36, which are formed in the molding process to be perpendicular to the initial frontal surface of the geometric reference surface(s) 48.

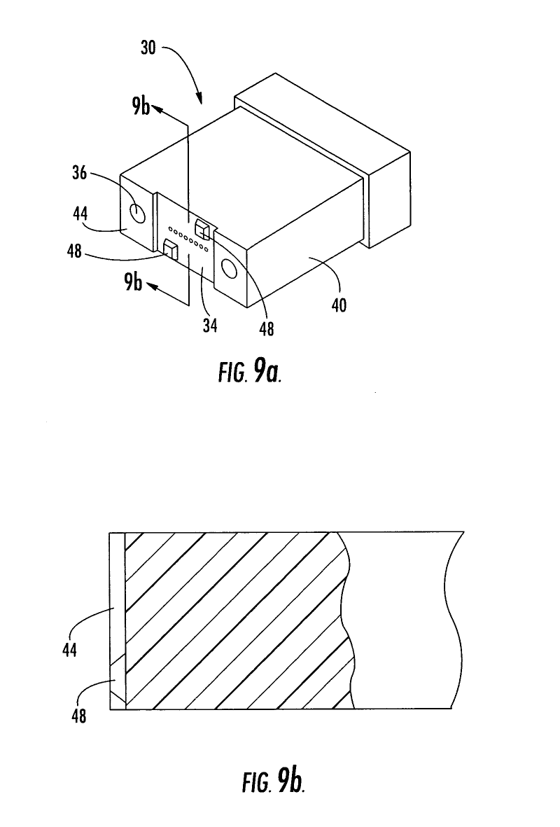

Referring to FIGS. 9a-9d, in a still further embodiment a molded fiber optic ferrule 30 having a pair of outwardly extending geometric reference features 48 is shown. As shown in FIG. 9a, a pair of rectangular-faced geometric reference features 48 protrudes from the surface of the end face 34 at diametrically opposed locations between a pair of bumpers 44. Although not shown, the optical fibers may be flush with the surface of the end face 34, but preferably protrude therefrom. As the protruding optical fibers and the geometric reference features 48 are polished, the frontal surface area of the geometric references features 48 increases. By measuring the height of the geometric reference features 48 or the area of the frontal surfaces after polishing, the height of the polished optical fibers may be determined. In addition, by comparing the frontal surface areas of the geometric reference features 48 after polishing, it may be determined whether or not the optical fibers were polished normal to the longitudinal axis of the ferrule body 40. Optical fibers that are polished normal to the longitudinal axis of the ferrule body 40 result in the pair of geometric reference features 48 having an equal surface area after polishing.

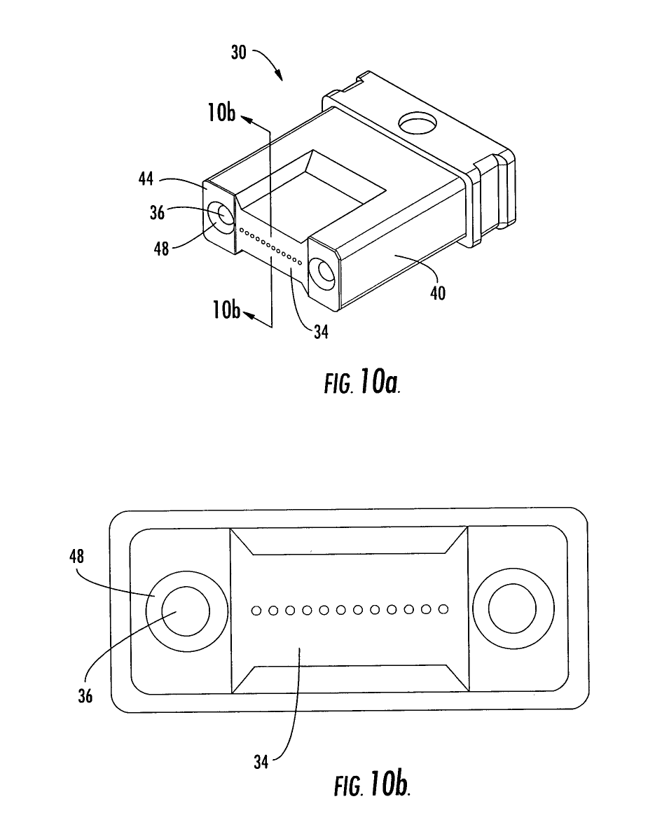

Referring to FIGS. 10a and 10b, in a still further embodiment a molded fiber optic ferrule 30 is shown having geometric reference features 48 disposed within the guide pin openings 36. In this embodiment, the geometric reference features 48 comprise a multifunctional version of the chamfer that already exists around the guide pin openings 36 of certain ferrule designs. The height of optical fibers (not shown) protruding from the fiber bores 42 may be determined by measuring the change in the depth of the geometric reference features 48 disposed within the guide pin openings 36 on bumpers 44. The end face 34 lies in the same plane as the innermost edge of the geometric reference features 48. Although not shown, the optical fibers may be flush with the surface of the end face 34, but preferably protrude therefrom. As the optical fibers are polished normal to the longitudinal axis of the ferrule body 40, the bumpers 44 and the geometric reference features may decrease in depth. By measuring and comparing the depth of each geometric reference feature 48 after polishing, it may be determined whether or not the optical fibers were polished normal to the longitudinal axis of the ferrule body 40. Optical fibers that are polished normal to the longitudinal axis of the ferrule body 40 result in the geometric reference features 48 having an equal depth after polishing. In addition to serving as a reference feature for the polishing angle, the tapered surface of the geometric reference features 48 may be used to help guide the guide pins into their respective guide pin opening 36.

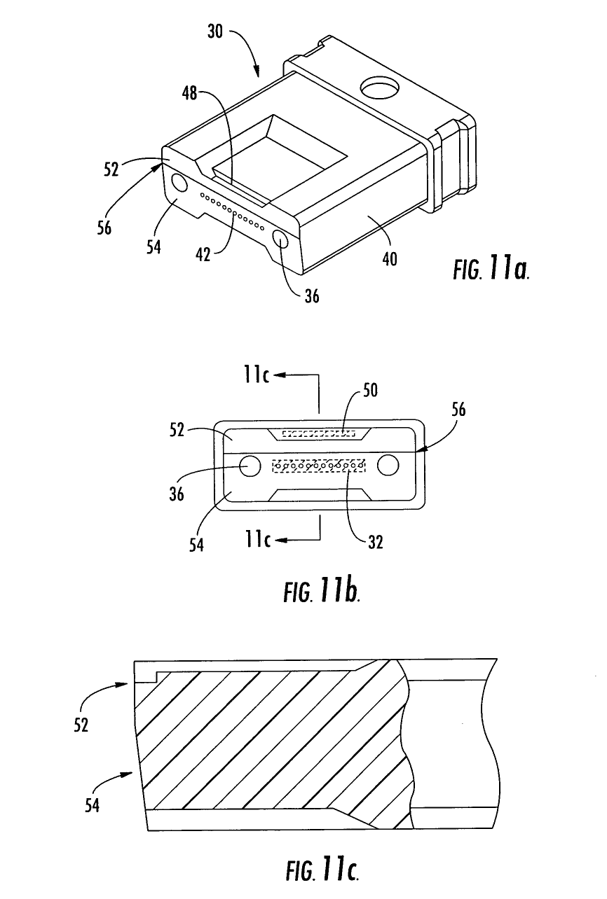

Referring to FIGS. 11a-11c, in a still further embodiment a molded fiber optic ferrule 30 is shown having an end face 34 comprising a first end face surface 52 disposed normal to the longitudinal axis of the ferrule body 40, and a second end face surface 54 disposed at an angle relative to the first end face surface 52 and the longitudinal axis of the ferrule body 40. The first end face surface 52 and the second end face surface 54 are divided by a separation line 56 that extends above the fiber bores 42 and the guide pin openings 36 in the direction of the long axis (i.e., X-direction) of the end face 34. The angle of the second end face surface 54 relative to the first end face surface 52 is in the range from about 6 degrees to about 12 degrees, preferably from about 6 degrees to about 10 degrees, more preferably from about 7.8 to about 8.2 degrees. In this embodiment, the plurality of fiber bores 42 and the guide pin openings 36 open through the second end face portion 54. The fiber bores 42 and the longitudinal axis of the guide pin openings 36 remain parallel to the longitudinal axis of the ferrule body 40. Although not shown, the optical fibers may be flush with the second end face surface 54, but preferably protrude a predetermined amount from the second end face surface 54 and beyond the first end face surface 52. The ends of the optical fibers may be polished parallel to the first end face surface 52 and normal to the longitudinal axis of the ferrule body 40. Conversely, the ends of the optical fibers may be polished parallel to the second end face surface 54 and at an angle relative to the first end face surface 52 and the longitudinal axis of the ferrule body 40. Preferably, the polishing angle conforms to the angle between the first end face surface 52 and the second end face surface 54.

The end face 34 having a normal first end face surface 52 and an angled second end face surface 54 is an integrally formed, molded feature that is not machined subsequent to molding. In this regard, one mold may be used to produce a fiber optic ferrule 30 having an end face normal to the longitudinal axis of the ferrule body 40, and a fiber optic ferrule 30 having an end face disposed at an angle to the first end face surface 52 and the longitudinal axis of the ferrule body 40. The end face surface 52, 54 that is to be parallel to the optical fiber polishing angle is predetermined. By molding a ferrule 30 having two end face surfaces with a predetermined angle between them, as opposed to machining the angle subsequent to the molding process, the reproducibility of substantially identical parts is improved.

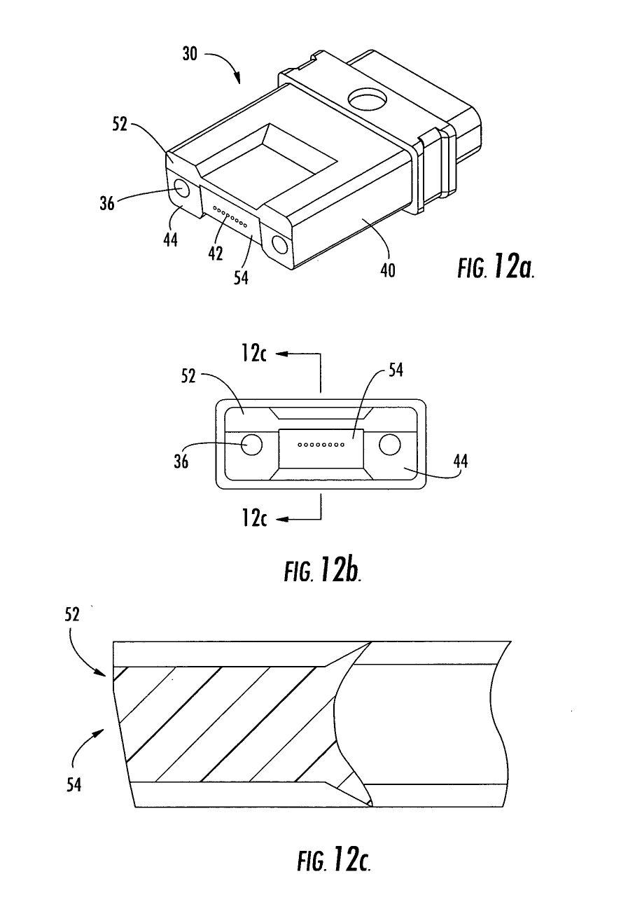

Referring to FIGS. 12a-12c, in a still further embodiment a molded fiber optic ferrule 30 is shown having an end face comprising a first end face surface 52 disposed normal to the longitudinal axis of the ferrule body 40, and a second end face surface 54 disposed at an angle relative to the first end face surface 52 and the longitudinal axis of the ferrule body 40. The first end face surface 52 and the second end face surface 54 are divided by a separation line 56 that extends above the fiber bores 42 and the guide pin openings 36 in the direction of the long axis (i.e., X-direction) of the end face 34. The angle between the first end face surface 52 and the second end face surface 54 is in the range from about 6 degrees to about 12 degrees, preferably from about 6 degrees to about 10 degrees, more preferably from about 7.8 to about 8.2 degrees. In this embodiment, the plurality of fiber bores 42 open through the second end face surface 54, while the guide pin openings 36 open through the bumpers 44. The fiber bores 42 and the longitudinal axis of the guide pin openings 36 remain parallel to the longitudinal axis of the ferrule body 40. Although not shown, the optical fibers may be flush with the second end face surface 54, but preferably protrude a predetermined a mount from the second end face surface 54 and beyond the first end face surface 52. The ends of the optical fibers may be polished parallel to the first end face surface 52 and normal to the longitudinal axis of the ferrule body 40. Conversely, the ends of the optical fibers may be polished parallel to the second end face surface 54 and at an angle relative to the first end face surface 52 and the longitudinal axis of the ferrule body 40. Preferably, the polishing angle conforms to the angle between the first end face surface 52 and the second end face surface 54.

After polishing, the height of the optical fibers may be determined by measuring the resulting height of the bumpers 44. In addition, by comparing the respective height of each bumper 44, it may be determined whether or not the polishing angle was parallel to the second end face surface 54. A polishing angle parallel to the second end face surface 54 and at an angle relative to the first end face surface 52 and the longitudinal axis of the ferrule body 40 results in the bumpers 44 having equal heights. Likewise, a polishing angle parallel to the first end face surface 52 and normal to the longitudinal axis of the ferrule body 40 results in the bumpers 44 having equal heights at corresponding locations.

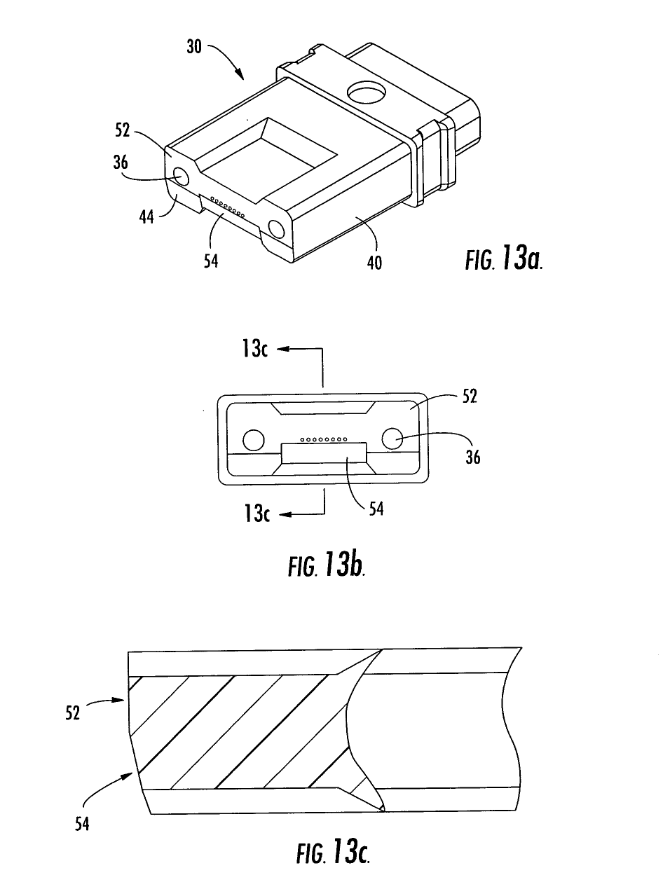

Referring to FIGS. 13a-13c, in a still further embodiment a molded fiber optic ferrule 30 is shown having an end face comprising a first end face surface 52 disposed normal to the longitudinal axis of the ferrule body 40, and a second end face surface 54 disposed at an angle relative to the first end face surface 52 and the longitudinal axis of the ferrule body 40. The first end face surface 52 and the second end face surface 54 are divided by a separation line 56 that extends below the fiber bores 42 and the guide pin openings 36 in the direction of the long axis (i.e., X-direction) of the end face 34. The angle between the first end face surface 52 and the second end face surface 54 is in the range from about 6 degrees to about 12 degrees, preferably from about 6 degrees to about 10 degrees, more preferably from about 7.8 to about 8.2 degrees. The plurality of fiber bores 42 and the guide pin openings 36 open through the first end face surface 52. The fiber bores 42 and the longitudinal axis of the guide pin openings 36 remain parallel to the longitudinal axis of the ferrule body 40. In this embodiment, the optical fibers may be polished parallel to the first end face surface 52 and normal to the longitudinal axis of the ferrule body 40, or may be polished parallel to the second end face surface 54.

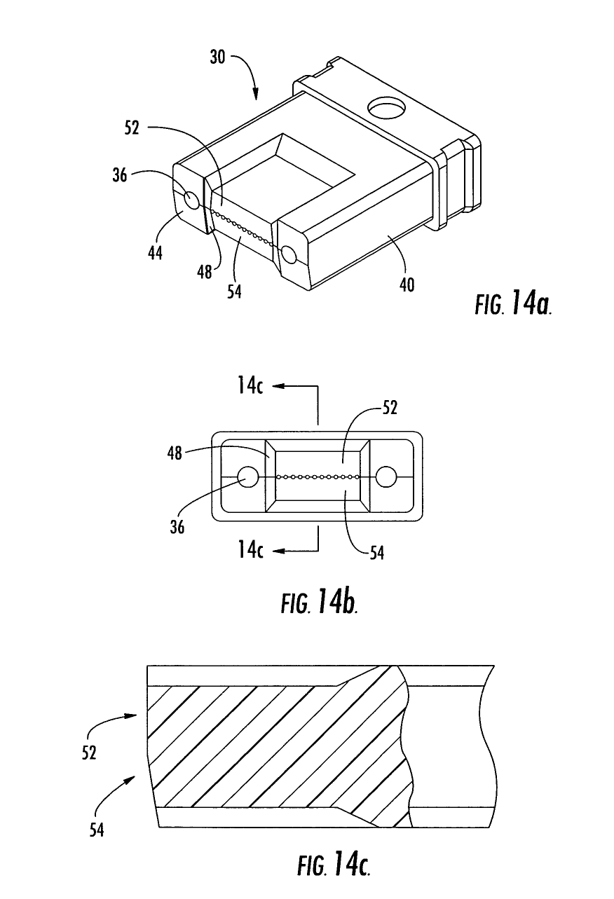

Referring to FIGS. 14a-14c, in a still further embodiment a molded fiber optic ferrule 30 is shown having an end face comprising a first end face surface 52 disposed normal to the longitudinal axis of the ferrule body 40, and a second end face surface 54 disposed at an angle relative to the first end face surface 52 and the longitudinal axis of the ferrule body 40. The first end face surface 52 and the second end face surface 54 are divided into approximately equal surface areas by a separation line 56 that runs along the fiber bores 42 in the direction of the long axis (i.e., X-direction) of the end face 34. The angle between the first end face surface 52 and the second end face surface 54 is in the range from about 6 degrees to about 12 degrees, preferably from about 6 degrees to about 10 degrees, more preferably from about 7.8 to about 8.2 degrees. The plurality of fiber bores 42 and the guide pin openings 36 open through both the first end face surface 52 and the second end face surface 54 in an approximately equal amount. The fiber bores 42 and the longitudinal axis of the guide pin openings 36 are substantially parallel to the longitudinal axis of the ferrule body 40. Although not shown, the optical fibers may be flush with the separation line 56, but preferably protrude a predetermined amount from both the first end face surface 52 and the second end face surface 54. The ends of the optical fibers may be polished parallel to the first end face surface 52 and normal to the longitudinal axis of the ferrule body 40. Conversely, the ends of the optical fibers may be polished parallel to the second end face surface 54 and at an angle relative to the first end face surface 52 and the longitudinal axis of the ferrule body 40. In the latter instance, the polishing angle conforms to the angle between the first end face surface 52 and the second end face surface 54. The bumpers 44 protrude beyond both the first end face surface 52 and the second end face surface 54. The height of the bumpers 44 after polishing may be measured and used to determine the heights of the optical fibers and/or the polishing angle. After polishing and measuring the bumpers 44, the bumpers 44 may be removed to a predetermined depth, as previously described.

The molded multifiber ferrules 30 described herein may be employed in an optical network. In one example, the optical network may comprise an optical source, an optical cable comprising at least one optical fiber, at least one molded ferrule 30 attached to at least one end of the optical fiber, and an optical receiver. The at least one molded ferrule 30 may comprise a molded ferrule body 40 having an end face and defining a plurality of bores 42 extending lengthwise through the ferrule body 40 for receiving end portions of respective optical fibers 46, the ferrule body 40 further defining at least one opening through the end face 34 adapted to receive an alignment member for aligning the end portions of the respective optical fibers 46 with corresponding end portions of the opposing optical fibers 46 of a mating multifiber ferrule 30, and wherein the ferrule body 40 comprises at least one geometry feature 48 on an exterior surface of the ferrule body 40 that is formed during the molding process.

The foregoing provides a detailed description of exemplary embodiments of the invention. Although the molded fiber optic ferrule 30 and method of making the same have been described with reference to preferred embodiments and examples thereof, other embodiments and examples may perform similar functions and/or achieve similar results. All such equivalent embodiments and examples are within the spirit and scope of the present invention and are intended to be covered by the following claims.

1. A ferrule, comprising:
a molded ferrule body having an end face and defining a plurality of bores extending through the ferrule body for receiving end portions of respective optical fibers, the ferrule body further defining at least one opening trough the end face adapted to receive an alignment member for aligning the end portions of the respective optical fibers with corresponding end portions of optical fibers of a mating ferrule, the opening defining a longitudinal axis extending at least partially through the ferrule body; and
wherein the ferrule body comprises an integrally formed geometry feature on an exterior surface of the ferrule body; and
wherein the end face is not machined subsequent to molding the ferrule body.

2. The ferrule of claim 1, wherein the geometry feature is selected from the group consisting of a geometric reference feature, a reference datum, a measurement datum, a polishing angle, and an end face comprising a first surface and a second surface, wherein the first surface is normal to the longitudinal axis defined by the opening and the second surface is disposed at a predetermined angle relative to the first surface and the longitudinal axis.

3. The ferrule of claim 1, wherein the geometry feature is accessible for making visual measurements when the alignment member is received within the opening through the end face without the use of an interferometer having 3D capabilities.

4. A ferrule, comprising:
a molded ferrule body having an end face and defining a plurality of bores extending through the ferrule body for receiving end portions of respective optical fibers, the ferrule body further defining at least one opening through the end face adapted to receive an alignment member for aligning the end portions of the respective optical fibers with corresponding end portions of optical fibers of a mating ferrule, the opening defining a longitudinal axis extending at least partially through the ferrule body, the ferrule body further defining a molded geometric reference feature on an exterior surface of the ferrule body; and
wherein the end face is not machined subsequent to molding the ferrule body, and
wherein the geometric reference feature eliminates the need for using a truncated precision measurement pin to determine the angularity of a plane defined by a region of interest on the end face of the ferrule body.

5. The ferrule of clam 4, further comprising at least one bumper extending outwardly from the end face of the ferrule body.

6. The ferrule of claim 5, wherein the geometric reference feature is located on the at least one bumper.

7. The ferrule of claim 4, wherein the geometric reference feature is recessed on the ferrule body relative to the end face.

8. The ferrule of claim 4, wherein the geometric reference feature protrudes from the end face.

9. The ferrule of claim 4, wherein the geometric reference feat is disposed within the at least one opening.

10. The ferrule of claim 4, wherein the geometric reference feature is accessible for making visual measurements when the alignment member is received within the opening through the end face without the use of an interferometer having 3D capabilities.

11. The ferrule of claim 4, wherein the geometric reference feature is not altered throughout the useful life of the ferrule.

12. A multifiber ferrule for a fiber optic connector, the ferrule comprising:
a molded ferrule body having an end face comprising a first surface defining a first plane that is generally normal to a longitudinal axis of the ferrule body, and a second surface defining a second plane disposed at a predetermined angle relative to the first surface and the longitudinal axis of the ferrule body, the ferrule body further defining a plurality of bores extending through the ferrule body for receiving end portions of respective optical fibers, the ferrule body further defining at least one opening through the end face adapted to receive an alignment member for aligning the end portions of the respective optical fibers with corresponding end portions of optical fibers of a mating multifiber ferrule; and
wherein the end face is not machined subsequent to molding the ferrule body.

13. The multifiber ferrule of claim 12, further comprising a geometric reference feature operable for measuring the angularity of a plane defined by a region of interest on the end face; and
wherein the geometric reference feature is accessible for making visual measurements after assembly of the fiber optic connector without the use of an interferometer having 3D capabilities, thereby eliminating the need for using a truncated precision measurement pin to measure the angularity of the plane defined by the region of interest on the end face.

14. A method for determining the angularity of a plane defined by at least a portion of an end face of a ferrule, comprising:
providing a ferrule having a ferrule body, an end face and a geometric reference feature on an exterior surface of the ferrule body proximate the end face;
measuring a reference plane defined by the geometric reference feature;
measuring the plane defined by the at least a portion of the end face of the ferrule; and
determining at least one end face angle based upon an angular difference between the reference plane defined by the geometric reference feature and the plane defined by the at least a portion of the end face of the ferrule.

15. The method of claim 14, wherein the geometric reference feature is accessible during the measuring steps for making visual measurements without the use of an interferometer having 3D capabilities.

16. The method of claim 14, wherein the measuring steps eliminate the need for using a truncated precision measurement pin to determine the end face angle of the ferrule.

17. A method of forming a ferrule, comprising:
molding a ferrule body comprising an end face and defining a plurality of bores extending through the ferrule body for receiving end portions of respective optical fibers, the ferrule body also defining at least one opening through the end face adapted to receive a guide pin for aligning the end portions of the respective optical fibers with corresponding end portions of optical fibers of a mating ferrule, the opening defining a longitudinal axis extending at least partially through the ferrule body; and
wherein the ferrule body comprises a geometry feature on an exterior surface of the ferrule body that is formed by molding and is not subsequently machined.

18. The method of claim 17 wherein the geometry feature is accessible for making visual measurements without the use of an interferometer having 3D capabilities, thereby eliminating the need for using a truncated precision measurement pin to determine the angularity of at least a portion of the end face of the ferrule.

19. The method of claim 17, wherein the geometry feature is selected from the group consisting of a geometric reference feature, a reference datum, a measurement datum, a polishing angle, and an end face comprising a first surface and a second surface, wherein the first surface is generally normal to the longitudinal axis and the second surface is disposed at a predetermined angle relative to the first surface and the longitudinal axis.

20. A method of forming a multifiber ferrule for a fiber optic connector, comprising:
molding a ferrule body comprising an end face and defining a plurality of bores extending through the ferrule body for receiving end portions of respective optical fibers, the ferrule body also defining at least one opening through the end face adapted to receive an alignment member for aligning the end portions of the respective optical fibers with corresponding end portions of optical fibers of a mating multifiber ferrule, the opening defining a longitudinal axis extending at least partially through the ferrule body, the end face comprising a first surface defining a first plane that is generally normal to the longitudinal axis and a second surface defining a second plane disposed at a predetermined angle relative to the first surface and the longitudinal axis of the ferrule body, the ferrule body further comprising an integrally formed geometry feature proximate the end face; and
wherein the geometry feature comprises a reference surface that is accessible for making visual measurements after the alignment member is received within the opening through the end face defined by the ferrule body without the use of an interferometer having 3D capabilities; and
wherein the geometry feature eliminates the need for using a truncated precision measurement pin to determine the angularity of a plane defined by a region of interest on the end face.
